(19) United States
(12) Patent Application Publication
(10) Pub. No.: US 2004/0081422 A1
(43) Pub. Date: Apr. 29, 2004

(54) Display-provided portable electronic device

(75) Inventors: Kiyoshi Kawano, Saitama (JP); Gouji Funatsu, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/687,638

(22) Filed: Oct. 20, 2003

(30) Foreign Application Priority Data
Oct. 21, 2002 (JP) P2002-305804

(51) Int. Cl. G02B 6/10

(52) U.S. Cl. 385/146

(57) ABSTRACT

A portable electronic device provided with a folding type image-indicating device is provided. The electronic device comprises an operational member and a light source. The operational member is transparent or translucent and it is exposed when the image-indicating device is folded. The light source supplies light to the operational member. When electric power is supplied to the image-indicating device, the light supplied from the light source illuminates the operational member.

### BACKGROUND OF THE INVENTION

1. Field of the Invention

The present invention relates to an electronic device provided with an image indicating function.

2. Description of the Related Art

Conventionally, portable electronic devices provided with an image-indicating device (e.g. an LCD monitor), such as a cellular phone, a personal digital assistant, an electronic dictionary, a digital still camera, and digital camera-provided binoculars, are known. These portable electronic devices are designed to be small-sized for convenience, thus a folding type image-indicating device, such as an LCD panel, is generally used. A folding type image-indicating device of a portable electronic device is folded so that the screen of the image-indicating device is folded inside to protect the screen from undesirable shock, dust, and so on. Therefore, the screen of the image-indicating device cannot be observed by a user when the image-indicating device is folded, so that the ON/OFF state of the image-indicating device cannot be verified by the user.

In order to overcome the above problem, a switch function, which automatically cuts the electric power supply to the image-indicating device when the image-indicating device is folded, may be provided. Further, a pilot light for indicating the power supply to the image-indicating device may be provided. However, it is difficult to provide these functions or devices in a portable electronic device which is required to be small and inexpensive. It is particularly difficult to achieve both a small size and a low cost for an image-indicating device provided binoculars, because the image-indicating device provided binoculars should include various functions in one body, such as a pair of telescopic lens systems, a photographing optical system, an image capturing system, an image-indicating mechanism for indicating a captured image, an interpupillary adjustment mechanism, and so on.

### SUMMARY OF THE INVENTION

Therefore, an object of the present invention is to provide a portable electronic device provided with a folding type image-indicating device with a compact and simple structure that can easily verify the state of the image-indicating device while the image-indicating device is folded.

According to the present invention, a portable electronic device provided with a folding type image-indicating device is provided. The electronic device comprises an operational member and a light source. The operational member is transparent or translucent and it is exposed when the image-indicating device is folded. The light source supplies light to the operational member. When the electric power is supplied to the image-indicating device, the light supplied from the light source illuminates the operational member.

### BRIEF DESCRIPTION OF THE DRAWINGS

The objects and advantages of the present invention will be better understood from the following description, with reference to the accompanying drawings in which:

FIG. 1 is a plan view showing an inner arrangement and structure of a digital-camera-provided binoculars of an embodiment to which the present invention is applied;

FIG. 2 is a cross-sectional view taken along the line II-II of FIG. 1, which shows the retracted position;

FIG. 3 is a cross-sectional view, similar to FIG. 2, which shows an extended position;

FIG. 4 is a plan view of a support-plate assembly provided inside a casing;

FIG. 5 is a plan view of the right and left mount plates arranged above the support-plate member;

FIG. 6 is an elevational view observed along line VI-VI of FIG. 5;

FIG. 7 is a cross-sectional elevational view along line VII-VII of FIG. 1;

FIG. 8 is a cross-sectional elevational view of an alternate embodiment corresponding to FIG. 7;

FIG. 9 is a perspective view of the display-provided binoculars of which the ceiling is partly cutaway;

FIG. 10 is a magnified cross-sectional elevational view of the display switch along the longitudinal (lateral) direction of the binoculars; and

FIG. 11 is a magnified perspective view around the display switch.

### DESCRIPTION OF THE PREFERRED EMBODIMENTS

The present invention is described below with reference to the embodiment shown in the drawings.

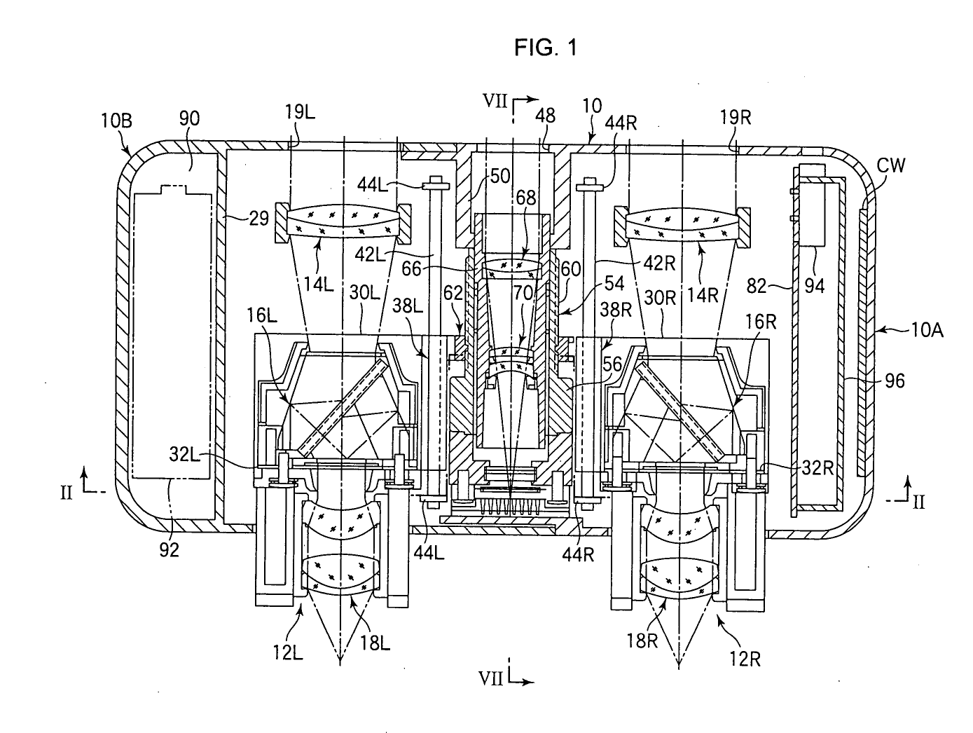

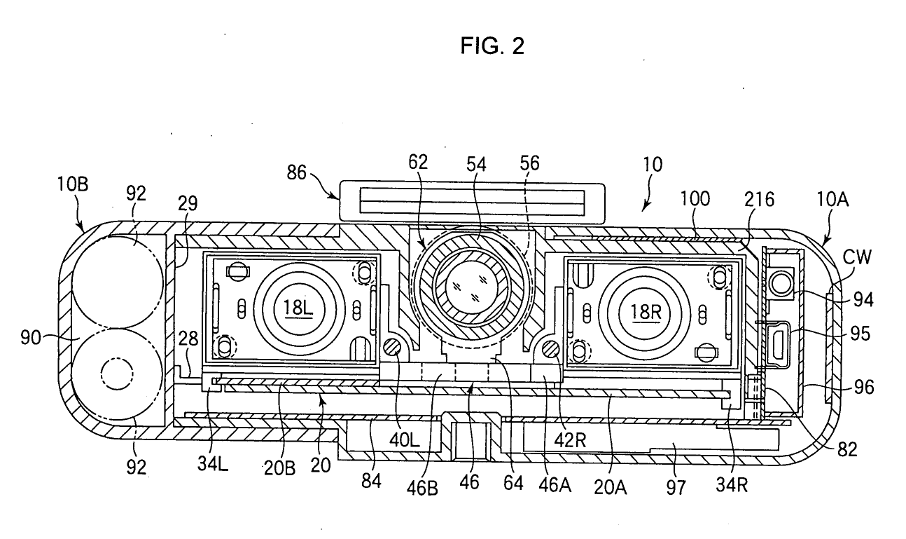

FIG. 1 is a plan view showing an inner arrangement and structure of the binoculars provided with a digital camera, which is an embodiment to which the present invention is applied. FIG. 2 is a cross-sectional view taken along the line II-II of FIG. 1. In the present embodiment, the digital-camera-provided binoculars are covered with a rectangular parallelepiped casing 10 which is comprised of a main casing section 10A and a movable casing section 10B.

Inside the casing 10, a pair of telescopic lens systems 12R and 12L is provided. The telescopic lens systems 12R and 12L are symmetrically arranged and are used for binocular observation with the right and left eyes. The right telescopic lens system 12R is assembled in the main casing section 10A, and is comprised of an objective lens system 14R, an erecting prism system 16R, and an ocular lens system 18R. On the front of the main casing section 10A, an objective window 19R which is aligned with the right objective lens system 14R is formed. On the other hand, the left telescopic lens system 12L is assembled in the movable casing section 10B, and is comprised of an objective lens system 14L, an erecting prism system 16L, and an ocular lens system 18L. On the front of the movable casing section 10B, an objective window 19L which is aligned with the left objective lens system 14L is formed.

Note that, in the following description, for convenience of explanation, the front side and the rear side of the binoculars are respectively defined as the objective side and ocular side of the telescopic lens systems 12R and 12L of the binoculars.

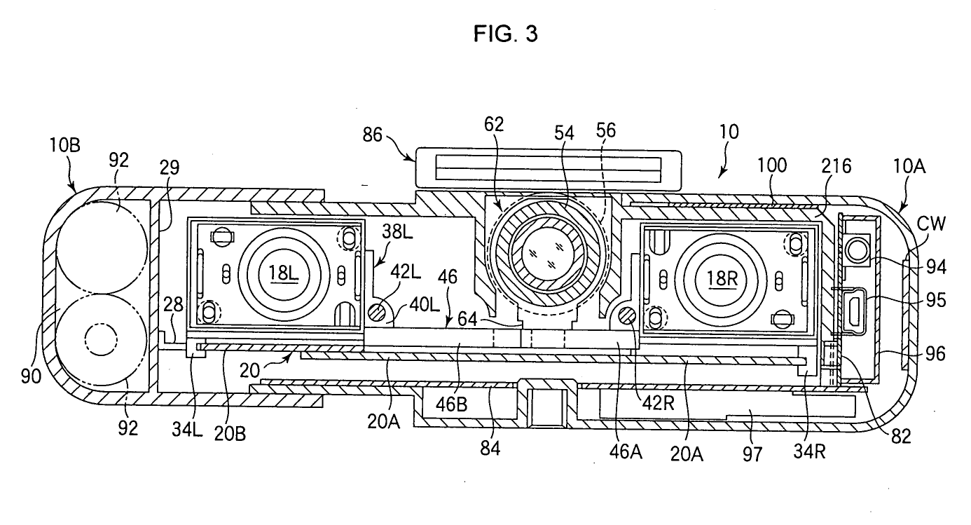

The movable casing section 10B is slidably engaged with the main casing section 10A so that the movable casing section 10B can be drawn out from the main casing section 10A in the lateral direction. Namely, the movable casing section 10B can be arbitrarily moved or slid in the lateral direction in relation to the main casing section 10A between a retracted position as shown in FIG. 2 and a maximum-extended position as shown in FIG. 3. A suitable friction is designed to act on the slidably engaged surfaces of the movable casing section 10B and the main casing section 10A. Thereby, a certain extension or extraction force must be exerted on the movable casing section 10B and the main casing section 10A to slide the movable casing section 10B relative to the main casing section 10A. Therefore, the movable casing section 10B can be suspended at an arbitrary position between the retracted position (FIG. 2) and the maximum-extended position (FIG. 3) by means of the friction between the slidably engaged surfaces.

As it is obvious from FIG. 2 and FIG. 3, when the movable casing section 10B is drawn out or extended from the main casing section 10A, the left telescopic lens system 12L is conveyed with the movable casing section 10B, while the right telescopic lens system 12R remains still with the main casing section 10A. Namely, an interpupillary adjustment can be carried out by extending the movable casing section 10B from the main casing section 10A and adjusting a distance between the optical axes of the ocular lens systems 18R and 18L of the right and left telescopic lens systems 12R and 12L.

In the present embodiment, the objective lens system 14R of the right telescopic lens system 12R is fixedly mounted on the main casing section 10A, while the erecting prism system 16R and the ocular lens system 18R are movable back and forth with respect to the objective lens system 14R, whereby the focus of the right telescopic lens system 12R is adjusted. Similarly, the objective lens system 14L of the left telescopic lens system 12L is fixedly mounted on the movable casing section 10B, while the erecting prism system 16L and the ocular lens system 18L are movable back and forth with respect to the objective lens system 14L, whereby the focus of the left telescopic lens system 12L is adjusted.

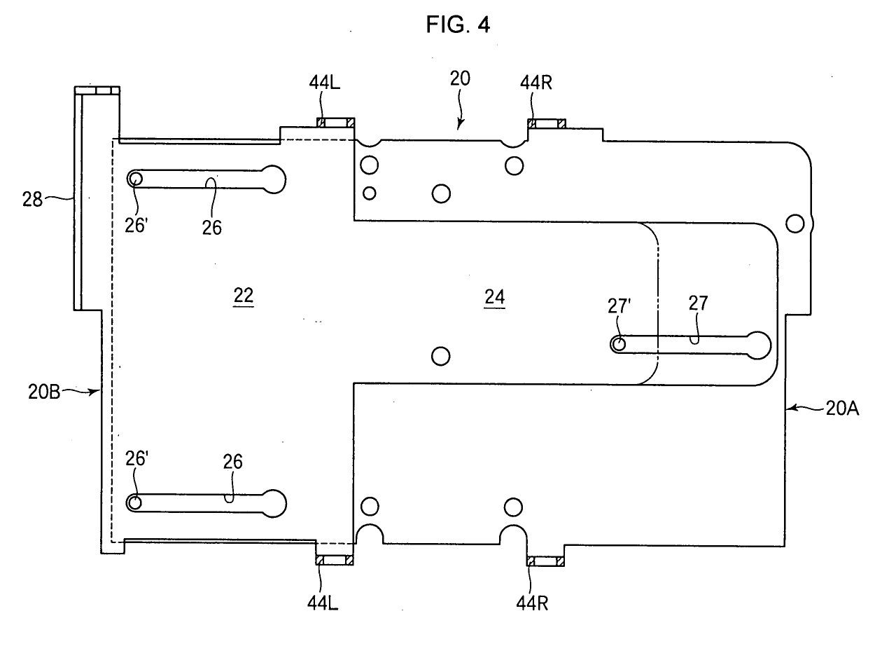

To carry out the above-described interpupillary adjustment and the focusing, a support-plate assembly 20, as shown in FIG. 4, is provided on the bottom side of the casing 10. Note that, the support-plate assembly 20 is omitted in FIG. 1, so that undue complexity of the drawing is prevented.

The support-plate assembly 20 comprises a rectangular fixed-plate member 20A, which is suitably secured to the main casing section 10A, and a slide-plate member 20B, which is slidably laid on the fixed-plate member 20A and suitably secured to the movable casing section 10B. The slide-plate member 20B has a rectangular section 22 with a width substantially equal to the back and forth length of the rectangular fixed-plate member 20A, and an extended section 24 which integrally extends out from the rectangular section 22 in the right direction. The objective lens system 14R of the right telescopic lens system 12R is fixedly disposed at a predetermined position on the rectangular fixed-plate member 20A and the objective lens system 14L of the left telescopic lens system 12L is fixedly disposed at a predetermined position on the slide-plate member 20B.

On the rectangular section 22 of the slide-plate member 20B, there is formed a pair of guide slots 26. Further a guide slot 27 is formed on the extended section 24 of the slide-plate member 20B. On the other hand, a pair of guide bolts 26′, which slide along the guide slots 26, and guide bolt 271, which slides along the guide slot 27, are securely attached to the fixed-plate member 20A. The guide slots 26 and 27 have the same length in the lateral direction of the binoculars. The length corresponds to the movable distance of the extendable casing 10, which is described by the transformation of casing 10 from the retracted position of FIG. 2 to the maximum-extended position of FIG. 3.

As apparent from FIG. 2 and FIG. 3, the support-plate assembly 20 is arranged in the casing 10 at a suitable distance from the bottom of the casing 10. The rectangular fixed-plate member 20A is suitably secured to the main casing section 10A, and the slide-plate member 20B is suitably secured to the movable casing section 10B. Note that, in the present embodiment, a support section 28 is provided along the left side end of the rectangular section 22 in order to secure the slide-plate member 20B to the movable casing section 10B. Namely, the support section 28 is suitably affixed to the partition 29 provided in the movable casing section 10B.

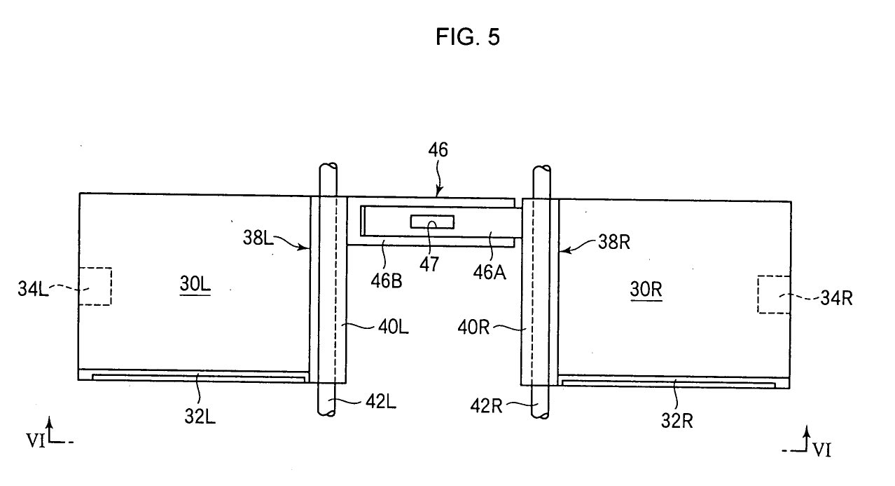

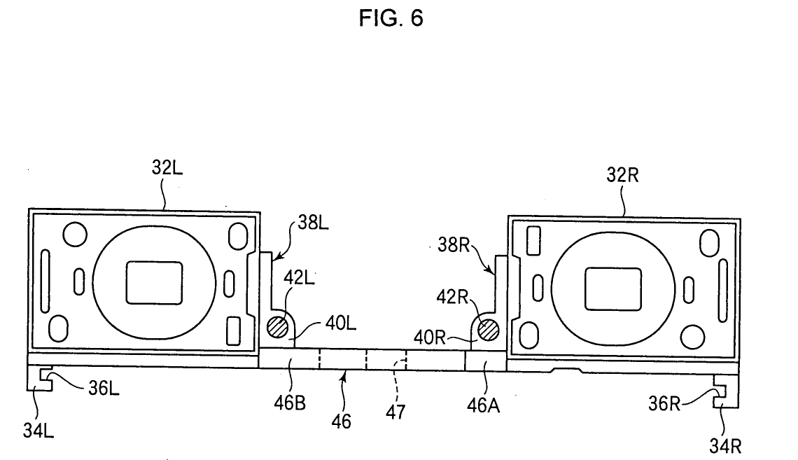

In FIG. 5, a right mount-plate 30R on which the erecting prism system 16R of the right telescopic lens system 12R is mounted and a left mount-plate 30L on which the erecting prism system 16L of the left telescopic lens system is mounted, are depicted. As is apparent from FIG. 5 and FIG. 6, upright plates 32R and 32L are provided for each of the right mount-plate 30R and the left mount-plate 30L along the respective rear side edges. As shown in FIG. 1, the right upright plate 32R is used as a frame for attaching the right ocular lens system 18R and the left upright plate 32L is used as a frame for attaching the left ocular lens system 18L.

As shown in FIG. 6, a guide shoe 34R is attached on the underside of the right mount plate 30R along the right side edge the plate 30R. A groove 36R that slidably receives a right side edge of the rectangular fixed-plated member 20A is formed on the guide shoe 34R, as shown in FIG. 2 and FIG. 3. Further, along the left side edge of the right mount plate 30R, a sidewall 38R is provided. The lower side of the sidewall 38R is formed as a swollen portion 40R where a through bore for slidably receiving a guide rod 42R is formed. Both ends of the guide rod 42R are fitted into holes formed on a pair of support pieces 44R that are integrally provided on each of the front and rear side edges of the rectangular fixed-plate member 20A, so that the guide rod 42R is suitably secured to the fixed-plate member 20A.

On the other hand, a guide shoe 34L is attached on the underside of the left mount plate 30L along the left side edge of the plate 30L. A groove 36L that slidably receives a left side edge of the slide-plated member 20B is formed on the guide shoe 34L, as shown in FIG. 2 and FIG. 3. Further, along the right side edge of the left mount plate 30L, a sidewall 38L is provided. The lower side of the sidewall 38L is formed as a swollen portion 40L, where a through bore for slidably receiving a guide rod 42L is formed. Both ends of the guide rod 42L are fitted into holes formed on a pair of support pieces 44L that are integrally provided on each of the front and rear side edges of the slide-plate member 20B, so that the guide rod 42L is suitably secured to the slide-plate member 20B.

Note that, the pair of support pieces 44R and the pair of support pieces 44L are depicted in FIG. 1 despite the other elements of the support-plate assembly 20 being neglected.

Accordingly, as described above, the left telescopic lens system 12L is moved together with the movable casing section 10B when the movable casing section 10B is drawn out leftward from the main casing section 10A, so that the distance between the optical axes of the ocular lens system 18R and 18L of the right and left telescopic lens systems 12R and 12L, i.e. the interpupillary distance, can be adjusted.

Further, since the objective lens system 14R of the right telescopic lens system 12R is arranged in the front side of the right mount plate 30R, when the right mount plate 30R is translated back and forth along the guide rod 42R, the distance between the objective lens system 14R and the erecting prism system 16R can be adjusted, thereby the focusing operation for the right telescopic lens system 12R can be carried out. Similarly, since the objective lens system 14L of the left telescopic lens system 12L is arranged in the front side of the left mount plate 30L, when the left mount plate 30L is translated back and forth along the guide rod 42L, the distance between the objective lens system 14L and the erecting prism system 16L can be adjusted, thereby the focusing operation for the left telescopic lens system 12L can be carried out.

In order to translate the right and left mount plates 30R and 30L integrally along the respective guide rods 42R and 42L, while allowing lateral translation of the left mount plate 30L with respect to the right mount plate 30R, as most favorably described in FIG. 5, the mount plates 30R and 30L are interconnected to each other by an expandable coupler 46.

In detail, in the present embodiment, the coupler 46 is comprised of a bar member 46A that extends from the front end of the swollen portion 42R of the sidewall 40R and slide member 46B that slidably accepts the bar member 46A. Both the bar member 46A and the slide member 46B have a length that is sufficient for the bar member 46A and the slide member 46B to maintain slidable engagement even when the movable casing section 10B is extended from the retracted position (FIG. 2) to the maximum-extended position (FIG. 3). Thereby, the right mount plate 30R and left mount plate 30L can be integrally translated along the guide rods 42R and 42L, independent of the extended length of the movable casing section 10B from the main casing section 10A. Note that, the bar member 46A is provided with a rectangular bore 47, a function of the bore 47 will be explained later.

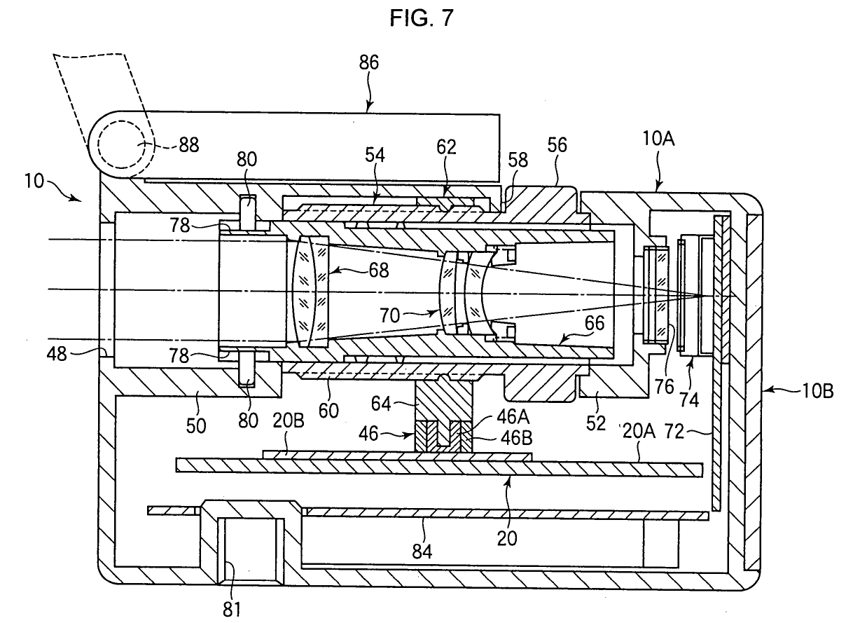

FIG. 7 is a cross sectional elevational view along line VII-VII of FIG. 1. As is apparent from FIG. 1 and FIG. 7, a circular opening 48 is formed in the front sidewall of the main casing section 10A. The circular opening 48 is positioned at the center of the casing 10 when the movable casing section 10B is positioned at the retracted position with respect to the main casing section 10A.

A fore sleeve member 50 protrudes inwardly and integrally from the inner face of the front sidewall of the main casing section 10A so as to surround the circular opening 48. Further, the top of the fore sleeve member 50 is integrated with the main casing section 10A, as shown in FIG. 7. On the other hand, a back sleeve member 52 is arranged on the rear side of the fore sleeve member 50, at a position separated from the fore sleeve member 50 by a predetermined distance. The back sleeve member 52 is integrally suspended from the inner face of the ceiling of the main casing section 10A.

The fore sleeve member 50 and the back sleeve member 52 are aligned and a focusing drive barrel 54 is rotatably supported between the fore and back sleeve members 50 and 52. The focusing drive barrel 54 is integrally provided with a focusing drive ring 56 which is arranged in the vicinity of the back sleeve member 54. A part of the focusing drive ring 56 is exposed outside the casing 10 through a rectangular opening 58 formed on the ceiling of the main casing section 10A. Note that, an exposed portion of the focusing drive ring 56 is rotated by a user when focusing the pair of telescopic lens systems 12R and 12L.

A male thread 60 is formed on the outer periphery of the focusing drive barrel 54, between the front end and the focusing drive ring 56. Further, the male thread 60 of the focusing drive barrel 54 mates with a female thread formed on the inner periphery of an annular frame 62. As is apparent from FIG. 2, FIG. 3, and FIG. 7, a protruding portion 64 that radially projects outward from the annular frame 62, is formed. The front end of the protruding portion 64 is fitted into the rectangular bore 47 formed on the bar member 46A of the coupler 46. Therefore, when the focusing drive ring 56 is rotated, the annular frame 62 is translated along its axial direction since the annular frame 62 is mated with the male thread 60 of the focusing drive barrel 54. Further, the direction of translation depends on the rotational direction of the focusing drive ring 56. Namely, the focusing drive barrel 54 and the annular frame 62 provide a motion conversion mechanism that transforms the revolution of the focusing drive barrel 54 to linear translation of the annular frame 62.

The right and left mount plate members 30R and 30L are also translated together with the annular frame 62, for the reason that the front end of the protruding portion 64 of the annular frame 62 is fitted into the rectangular bore 47 of the bar member 46A of the coupler 46. Namely, the distance between the objective lens systems (14R, 14L), and the respective erecting prism systems (16R, 16L) is adjusted by the rotation of the focusing drive ring 56, whereby the focusing operation for the telescopic lens systems (12R, 12L) is carried out.

In the present embodiment, the pair of telescopic lens systems 12R and 12L, for example, is designed to bring about pan-focus when the distance between the objective lens systems (14R, 14L) and respective erecting prism systems (16R, 16L) is minimum, whereby an object within a range of 40 m to infinity is in focus. When observing an object within a range of 2 m to 40 m, the image of the object is brought into focus by separating the erecting prism systems (16R, 16L) from their respective objective lens systems (14R, 14L) by the revolution of the focusing drive barrel 54. Naturally, when the erecting prism systems (16R, 16L) are separated by the maximum distance from the respective objective lens systems (14R, 14L), an object at a distance of 2 m is brought into focus.

Inside the focusing drive barrel 54, a lens barrel 66 is provided. A photographing optical system which comprises a first lens group 68 and a second lens group 70 is held in the lens barrel 66. On the other hand, an electric circuit board 72 which is provided with a solid-sate image-pickup device, such as a CCD 74, is attached on the inner face of the rear sidewall of the main casing section 10A. The CCD 74 is arranged so that the imaging surface of the CCD 74 is aligned with the photographing optical system (68, 70). At the rear end of the back sleeve member 52, an inner annular flange is provided for holding an optical low-pass filter. Namely, in the present embodiment, the display-provided binoculars are provided with a photographing function of a digital camera, and an image of the object is formed on the imaging surface of the CCD 74 through the optical low-pass filter 76 due the photographing optical system (68, 70).

A focusing mechanism does not need to be incorporate into the lens barrel 66 when the photographing optical system (68, 70) is designed to provide pan-focus, in which objects in the foreground and the background (a range from a certain distance to the infinite distance) are simultaneously made in focus, and when only an object within the pan-focus range is photographed. However, a focusing mechanism is required when the display-provided binoculars of the present embodiment is designed to photograph a foreground object (e.g. an object at 2 m distance), similar to a normal digital still camera.

Therefore, in the present embodiment, the female thread is formed on the inner periphery of the focusing drive barrel 54 and the male thread is formed on the outer periphery of the lens barrel 66, so that the lens barrel 66 is screwed into the focusing drive barrel 54. Further, the front end of the lens barrel 66 is fitted into the fore sleeve member 50 and a pair of key grooves 78 of predetermined length is formed along the longitudinal axis of the lens barrel 66 from the front end, as shown in FIG. 7. On the other hand, nearby the rear end of the fore sleeve member 50, a pair of bores is formed, extending in opposite radial directions, into which key elements 80 that mate with each of the key grooves 78 are planted. Namely, the rotation of the lens barrel 66 is prevented by the mating engagement between the key grooves 78 and the key elements 80.

Consequently, when the focusing drive barrel 54 is rotated by a rotational operation of the focusing drive ring 56, the lens barrel 66 is translated along its optical axis. Namely, the female thread formed on the inner periphery of the focusing drive barrel 54 and the male thread formed on the outer periphery of the lens barrel 66 provide a motion conversion mechanism that transforms the revolution (rotational movement) of the focusing drive barrel 54 to translation (linear movement) of the lens barrel 66. Thereby, the motion conversion mechanism functions as the focusing mechanism of the lens barrel 66.

The male thread 60, which is provided on the outer periphery of the focusing drive barrel 54 and the female thread provided on the inner periphery of the focusing drive barrel 54 are formed in opposite directions with respect to each other. Therefore, the lens barrel 66 is separated from the CCD 74 when the focusing drive barrel 54 is rotated in a direction which separate the erecting prism systems 16R and 16L from each of the objective lens systems 14R and 14L. As a result, an object in the foreground, which is outside of the pan-focus range, can be focused and its image can be clearly produced on the imaging surface of the CCD 74. Needless to say, the pitches of the male and female threads which are provided on the outer and inner periphery of the focusing drive barrel 54 are independent of each other, but are dependent on optical characteristics of the telescopic optical systems (12R, 12L) and the photographing optical system (67, 70).

As shown in FIGS. 2, 3, and 7, a female screw bore 81, into which a male screw of a camera platform of a tripod is screwed, is formed on the bottom surface of the main casing section 10A. As is apparent from FIG. 2, when the movable casing section 10B is at the retracted position with respect to the main casing section 10A, the female screw bore 81 is positioned at the center of the casing 10 in the lateral direction, right under the axis of the photographing optical system (68, 70). Further, as shown in FIG. 7, the female screw bore 81 is arranged nearby the forefront of the main casing section 10A.

As shown in FIGS. 1, 2, and 3, an electric power source circuit board 82 is provided inside the right end portion of the main casing section 10A and is suitably held by the main casing section 10A. Further, as shown in FIGS. 2 and 3, a main control circuit board 84 is provided between the base of the main casing section 10A and the support-plate assembly 20, so that the main control circuit board 84 is suitably supported by the base of the main casing section 10A. The main control circuit board 84 is provided with electronic devices, such as a microcomputer, memory, and the like. The CCD-mount electric circuit board 72 and the electric power source circuit board 82 are suitably connected to the main control circuit board 84 through flexible flat wire cables (not shown).

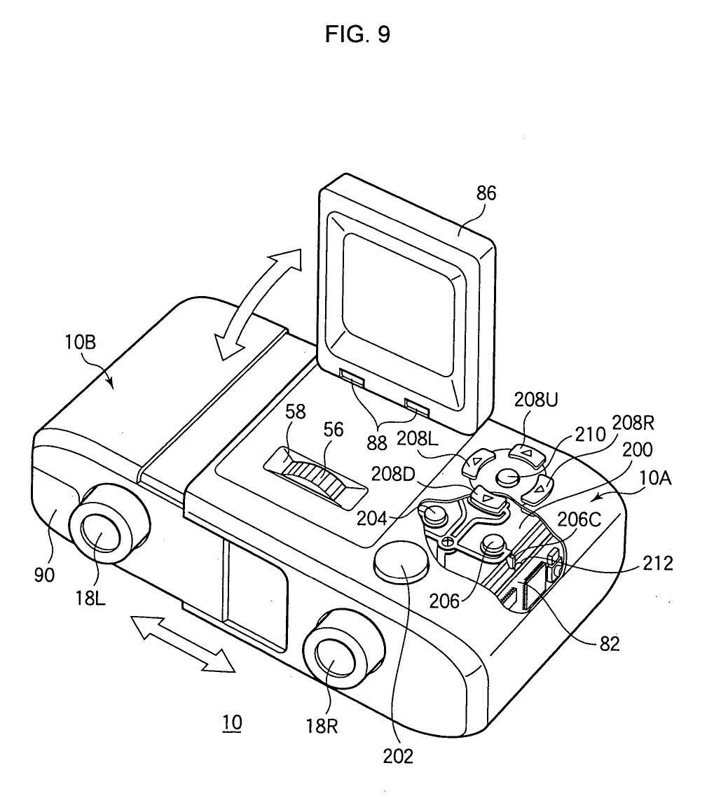

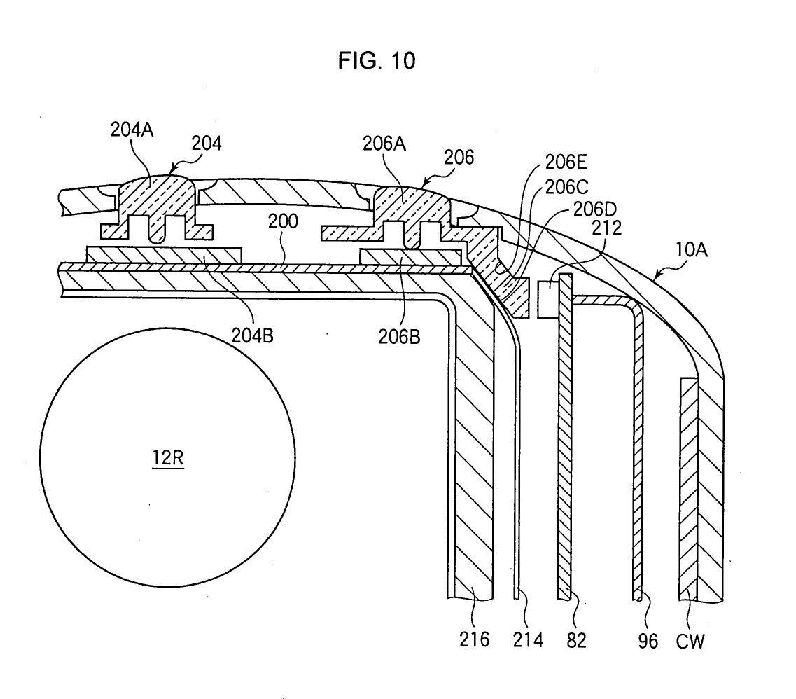

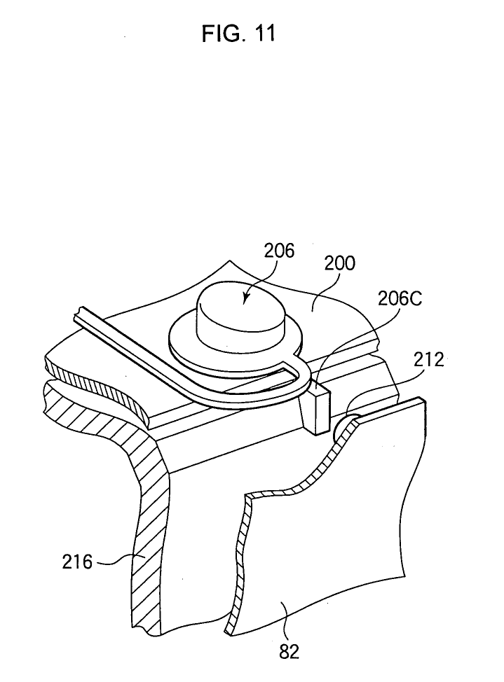

Further, between the ceiling of the main casing section 10A and the right objective lens system 14R or the right erecting prism system 16R, a switch circuit board 200 is arranged substantially in parallel with, and adjacent to, the ceiling of the main casing section 10A. Although it is neglected in FIG. 2 and FIG. 3, the switch circuit board 200 is provided with a switch group (refer FIGS. 9 and 11) which triggers imaging operations of the CCD 74 or which controls image indicating operations of the LCD monitor 86 provided on the outside of the ceiling of the main casing section 10A. Each of the operational sections of the switches is exposed outside the ceiling of the main casing section 10A through openings formed on the main casing section 10A. The switch circuit board 200 is connected to the main control circuit board 84 which is disposed on the base side of the main casing section 10A through a flexible flat wire cable (see FIG. 10) or the like. Note that, the details of the operational switch group will be discussed later.

An LCD monitor 86 is arranged on the ceiling of the main casing section 10A and is rotatably attached to a shaft 88 which is provided along the fore front edge of the ceiling as shown in FIG. 7. Normally, the LCD monitor 86 is positioned at a retracted position which is indicated by a solid line in FIG. 7. In this position, the screen of the LCD monitor 86 is laid down and faces the ceiling of the main casing section 10A, so that the screen of the LCD monitor 86 cannot be observed. When photographing operations are carried out by using the CCD 74, the LCD monitor 86 is manually rotated by a user from the retracted position to a display position, which is partly indicated by a broken line in FIG. 7. At this time, the screen of the LCD monitor 86 can be observed from the side of the ocular lens systems 18R and 18L.

As is apparent from FIGS. 1, 2, and 3, the left end portion of the movable casing section 10B is partitioned by the partition 29 and a battery chamber 90 is defined. The battery chamber 90 is loaded with two batteries 92 and supplies electric power to the electric power source circuit board 82 through electric power supply cords (not shown). The electric power is supplied from the electric power source circuit board 82 to the CCD on the CCD-mount electric circuit board 72, the electronic devices (e.g. the microcomputer, memory, and etc.) provided on the main circuit board 84, and the LCD monitor 86.

As shown in FIG. 2 and FIG. 3, the electric power source circuit board 82 is provided with connectors, such as the video output connector 94 and a USB connector 95. The video output connector 94 and the USB connector 95 are aligned vertically and are used for connecting an image processing computer (not shown) thereto. The electric power source circuit board 82 is covered by a shield cover 96 together with the connectors 94 and 95. The shield cover is formed of suitable conductive material, such as a steel sheet with a suitable thickness.

Namely, the electric power source circuit board 82, the connectors 94 and 95, and the shield cover 96 are installed inside the right end portion of the main casing section 10A while two batteries 92 are loaded inside the left end portion of the movable casing section 10B. Needless to say, the weight of the batteries 92 are comparatively heavy when it is compared with the weight of the above elements installed inside the right end portion of the main casing section 10A. Thereby, the lateral-weight balance of the display-provided binoculars is biased to the left side where the batteries 92 are loaded. Therefore, when a user supports the digital camera-provided binoculars with both hands, the weight supported by the left hand might be heavier than the weight supported by the right hand.

Consequently, in the present embodiment, the thickness of the shield cover 96 is determined in accordance with the weight of the batteries 92 to maintain lateral weight balance of the display-provided binoculars. Namely, weight of the electric power source circuit board 82, the connectors 94 and 95, and the shield cover 96 is counterbalanced by the weight of the two batteries 92. If necessary, as illustrated in FIGS. 1, 2, and 3, a counterbalance or a counterweight CW formed of relatively heavy metal, such as a steel plate, a zinc plate, or a lead plate, may be provided on the inner face of the right sidewall of the main casing section 10A, to counterbalance the digital camera-provided binoculars in the lateral direction. Needless to say, the position where the counterweight CW is attached is not restricted to the right sidewall of the main casing section 10A and the position can also be the shield cover 96.

Further, as illustrated in FIGS. 2 and 3, a CF card holder 97 is provided beneath the main control circuit board 84. A CF card, as a memory card, can be inserted into or pulled out from the CF card holder 97.

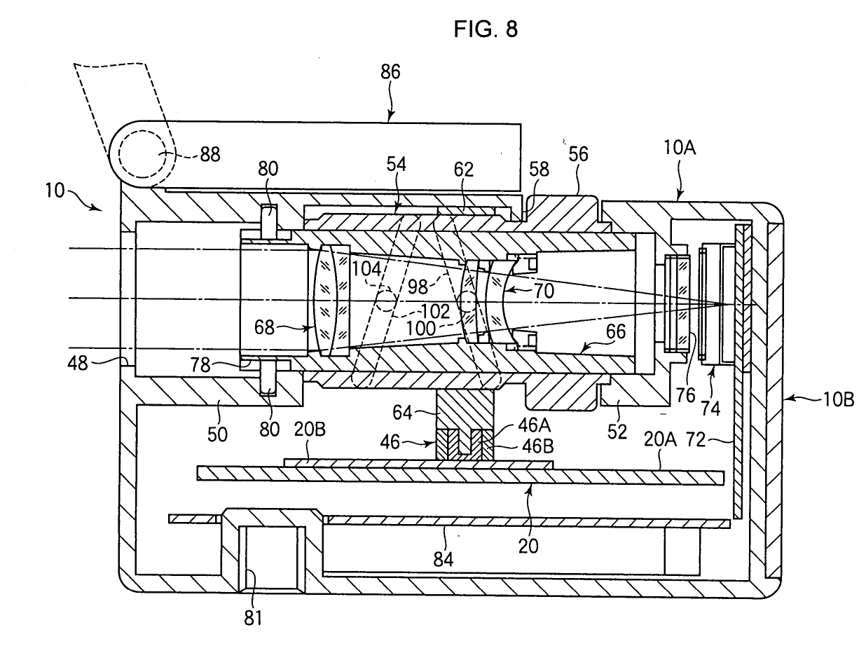

FIG. 8 is a cross sectional elevational view of an alternate embodiment corresponding to FIG. 7 of the above-explained embodiment. In the alternate embodiment illustrated in FIG. 8, the motion conversion mechanism for converting the revolution of the focusing drive barrel 54 to the translation of the annular frame 62 and the motion conversion mechanism for converting the revolution of the focusing drive barrel 54 to the translation of the lens barrel 66 are different from the above-described embodiment. However, other than this point, the digital camera-provided binoculars of FIG. 8 are substantially the same as the binoculars depicted in FIG. 1 through FIG. 7. Note that, in FIG. 8, the same reference numerals are used for the elements indicated in FIG. 7.

In the alternate embodiment illustrated in FIG. 8, a cam groove 98 (in FIG. 8, the cam groove 98 is illustrated by a phantom line as being developed in the plane) is formed on the outer periphery of the focusing drive barrel 54. A short shaft 100 or a cam follower that protrudes from the inner periphery of the annular frame 62 is slidably engaged with the cam groove 98. Namely, a motion conversion mechanism for converting rotation of the focusing drive barrel 54 to translation of the annular frame 62, is provided by the engagement of the cam groove 98 and the short shaft 100. On the other hand, the inner periphery of the focusing drive barrel 54 is provided with a cam groove 102 (in FIG. 8, the cam groove 102 is illustrated by a phantom line as being developed in the plane). A short shaft 104 or a cam follower that protrudes from the outer periphery of the lens barrel 66 slidably engages with the cam groove 102. Namely, a motion conversion mechanism for converting rotation of the focusing drive barrel 54 to translation of the lens barrel 66 is provided by the engagement of the cam groove 102 and the short shaft 104.

When a motion conversion mechanism is provided by the screw mating between a male and female thread, as described in the embodiment depicted in FIG. 1 through FIG. 7, the relation between the amount of rotation of the focusing drive barrel 54 and the amount of translation of the annular frame 62 or the lens barrel 66 is linear. However, the distance between the objective lens system (14R, 14L) and the erecting prism systems (16R, 16L), and the distance between imaging surface of the CCD 74 and the photographing optical system (68, 70) are not always linear to the distance to the in focused positions of the telescopic lens systems (12R, 12L) and the photographing optical system (68, 70).

Therefore, to provide a precise focusing mechanism for a pair of the telescopic lens systems (12R, 12L) or the photographing optical systems (68, 70), a motion conversion mechanism may be formed by the cam groove (98, 102) and the short shaft (100, 104), as in the present alternate embodiment shown in FIG. 8. This is because the above combinations facilitate the adoption of a motion conversion mechanism which produces a non-linear relation between the revolution of the focusing drive barrel 54 and translation of the annular frame 62 and the lens barrel 66. Thereby, precise focusing can be carried out in the pair of telescopic lens systems (12R, 12L) and the photographing optical system (68, 70). However, the motion conversion mechanism provided by the screw mating of the male and female threads, as shown in the embodiment of FIG. 1 to FIG. 7, has no problems in a practical use, since the telescopic lens systems (12R, 12L) and the photographing optical system (68, 70) have some degree of focal depth.

Next, with reference to FIG. 9 through FIG. 11, a drive-state monitoring function of the image-indicating device of the present embodiment will be explained. FIG. 9 is a perspective view of the display-provided binoculars. The ceiling of the main casing section 10A is partly cutaway to indicate the structure around the operational switches.

As depicted in FIG. 9, the switch group is provided on the right side of the ceiling of the main casing section 10A. For example, the switch group includes a release switch 202, menu switch 204, display switch 206, cursor key switches 208R, 208L, 208U, and 208D, and OK key 210. Electrical operations of the display-provided binoculars of the present embodiment are controlled by using the above switches included in the switch group. Note that, in FIG. 9, the shield cover 96 that covers the electric power source circuit board 82 is neglected for convenience.

The display-provided binoculars of the present embodiment comprises an image-capturing mode and a playback mode. When the image-indicating switch for the LCD monitor 86 is in the ON state, a certain image is displayed on the screen of the LCD monitor 86 in accordance with a selected mode. When the image-capturing mode is selected, images captured by the CCD 74 are displayed on the LCD monitor 86 as a motion video. Further, when the release switch 202 is operated, the still image captured by the CCD 74 is displayed on the LCD monitor 86 for a predetermined period and is stored in a built-in memory (not shown) or a memory CF card, for example. On the other hand, when the playback mode is selected, an image stored in the built-in memory or the memory CF card, for example, is reproduced on the LCD monitor 86.

In the present embodiment, the ON/OFF states of the image-indicating switch are switched from one to another by operating the display switch 206 or a slide lever (not shown) provided on the front of the main casing section 10A. Further, the selection of the above modes is carried out by operating the display switch 206, for example. The operation of the slide lever provided on the front face of the main casing section 10A is cooperative with the open and shut operations of a blackout plate (not shown) for shielding the circular opening 48 (see FIG. 1). Namely, the circular opening 48 of the lens barrel 60 is opened or shut in accordance with the operation of the slide lever.

The image-capturing mode is started when the slide lever is operated so as to open the blackout plate. At this time, the image-indicating switch is switched ON (the electric power is supplied to the LCD) and an object image formed on the imaging surface of the CCD 74 is photo-electrically converted into one frame of image signals. Further, the one frame of image signals is readout successively from the CCD 74 at a predetermined time interval, subjected to suitable image processes, and converted to digital image data. The one frame of image data is then temporally stored in a frame memory provided on the main control circuit board 84, and is output therefrom as digital video signals. Further, the digital video signals are converted to analog video signals and fed to the LCD monitor 86. Thereby, a moving picture of the object is displayed on the screen of the LCD monitor 86.

When the release switch is depressed, the one frame of imaged data stored in the above frame memory is readout as still image data and taken into a memory inside the microcomputer provided on the main control circuit board 84. Further, suitable image processes are performed on the still image data and the image data is then stored in the CF card in accordance with a predetermined format. The CF can be taken out from the CF card holder 97 when it is required and may be attached to a CF card driver of the image processing computer, thereby the one frame of image data is output as a photographed image by a printer, for example, after performing suitable image processes. On the other hand, when the display-provided binoculars is connected to the image processing computer through the connector 94 or 95, image data can be transmitted to the image processing computer without detaching the CF card from the CF card holder 97.

The mode is switched to the playback mode when the display switch 206 is depressed during the image-capturing mode. In the playback mode, an image stored in the built-in memory or a memory CF card is readout as digital video signals. The digital video signals are then converted to analog video signals and fed to the LCD monitor 86 after subjecting the signals to a suitable image processing. Note that, the selection of an image that is displayed on the LCD monitor 86 is carried out by operating the cursor keys 208R, 208L, 208U, and 208D and the OK key 210 which is used to decide the selection. Normally, the binoculars are kept in the sleep mode when the blackout plate is shut (when the image-capturing mode is OFF). However, when the display switch 206 is depressed, the above playback mode is started. Note that, the menu switch 204 is used when setting sub functions of the image-capturing mode or the playback mode, for example.

FIG. 10 is a magnified cross-sectional elevational view of the display switch 206 along the longitudinal (lateral) direction of the binoculars. Further, FIG. 11 is a magnified perspective view around the display switch 206.

The menu switch 204 and the display switch 206 each comprise an operational button section (204A, 206A) and a switch body (204B, 206B). The operational button sections 204A and 206A of the respective menu switch 204 and display switch 206, for example, are formed of a transparent or translucent resign and are disposed just above the respective switch bodies 204A and 206A which are equipped on the switch circuit board 200. Namely, when the operational button section 204A or 206A is depressed, the switch body 204B or 206B which is arranged beneath the depressed button section is depressed, so that the ON/OFF state of the operated switch is altered.

The display switch 206 is disposed on the ceiling of a casing 216 that holds the right telescopic lens system 12R and in the vicinity of the right side edge of the ceiling. At the right end of the operational button section 206A, a light guide section 206C which is integrally formed with the operational button section 206A, is connected. The light guide section 206C hangs down from the right side edge of the ceiling of the casing 216 to a predetermined position, along the sidewall of the casing. The right side of the casing 216 faces the electric power source circuit board 82 which is at a predetermined distance and the upper edge of the electric power source circuit board 82 is positioned substantially at the same height as the upper surface of the ceiling of the casing 216. An LED 212 is attached on the inner face of the electric power source circuit board 82 (i.e. the face which faces the casing 216) and faces the light guide section 206C of the display switch 206.

The LED 212, for example, is a multicolor type light source and can emit red and blue light. The light from the LED 212 is made incident into the light guide section 206C and transmitted to the operational button section 206A. In view of the fact that the operational button section 206A is formed of transparent or translucent material, the light transmitted to the operational button section 206A is diffused or scattered inside the operational button section 206A and emitted from its surface. Thereby, the operational button section 206A can be illuminated with the color of the light emitted from the LED 212. Note that, the LED 212 is illuminated when the image-indicating switch is in the ON state and the electric power is supplied to the LCD monitor 86. Further, the LED 212 is in the OFF when the image-indicating switch is OFF state and the LCD monitor 86 is OFF. Namely, in the present embodiment, the LED 212 illuminates a green color when the image-capturing mode is selected and a red color when the playback mode is selected.

In the present embodiment, a beveled surface (reflecting portion) 206D of the light guide section 206C, which contacts the side face of the casing 216, is formed as a flat plane having about 45 degrees of inclination to the light incident plane. Further, a beveled surface (reflecting portion) 206E that is substantially parallel with the beveled surface 206D is formed. Thereby, the beveled surfaces 206D and 206E are structured so that the incident light of the light guide section 206C is efficiently transmitted to the operational button section 206A. Namely, the light made incident to the light guide section 206C, first proceeds in the horizontal direction, strait toward the plane 206D, and is then reflected upward by the beveled surface 206D toward the beveled surface 206E. Further, the reflected light is reflected by the beveled surface 206E in the horizontal direction and led to the operational button section 206A.

Note that, in order to provide brighter illumination for the display switch 206, the bevel surfaces 206D and 206E may be formed as miller surfaces by metallizing each of the planes. On the other hand, weaker illumination of the display switch 206 may be achieved by neglecting the beveled surface 206E and providing only the beveled surface 206D.

In the present embodiment, the ridge of the casing 216 is chamfered to fit with the slanted reflecting beveled surface 206D of the light guide section 206C. Note that, on the right side edge of the switch circuit board 200, the flexible flat wire cable 214 which is connected to the main control circuit board 84 arranged on the bottom side of the main casing section 10A, is attached. As shown in FIG. 10, the flexible flat wire cable 214 is sandwiched between the casing 216 and the reflecting plane 206D of the light guide section 206C. Further, for convenience, the flexible flat wire cable 214 and the shield cover 96 are neglected in FIG. 11.

As described above, according to the display-provided binoculars of the present embodiment, a user can verify whether the electric power of the LCD monitor is in the ON state, without opening the LCD monitor 86, even when the folding type LCD monitor is folded and the screen is unable to be seen. Therefore, the user is alerted as to whether to turn off the power to the LCD monitor 86 and prevent the waste of the electric power. Namely, no additional exclusive elements are required and no design alteration in the form of the main casing section or arrangement of the elements is required. As a result, the display-provided binoculars that can prevent waste of electric power due to the image-indicating device being left on can be provided, with a simple and small structure, at a low cost, and without increasing the number of components.

Further, in the present embodiment, the display switch which relates to the function of the image-indicating device is illuminated, so that the user can easily recognize that electric power is being supplied to the image-indicating device. Furthermore, in the present embodiment, the color of the light source (LED) is changed in accordance with the mode relating to the functions of the image-indicating device, so that the user can easily know the current mode by looking at the color of the operational button.

Note that, although in the present embodiment, the invention is explained with reference to a display-provided binoculars, for example, the present invention can also be applied to a cellular phone, digital camera, and the like, which are provided with a folding type display. Further, in the present embodiment, the reflecting beveled surface (206D) is inclined at about 45 degrees, however, the angle in the present embodiment is only an example and various angles can be adopted unless they transmit incident light to the operational button section (206A). Further, a curvature surface or a surface comprised of a plurality of planes with various inclinations can also be applied.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-305804 (filed on Oct. 21, 2002) which is expressly incorporated herein, by reference, in its entirety.

1. A portable electronic device provided with a folding-type image-indicating device, comprising:
an operational member that is transparent or translucent and exposed when said image-indicating device is folded; and
a light source that supplies light to said operational member;
wherein said operational member is illuminated by the light supplied from said light source when electric power is supplied to said image-indicating device.

2. A device according to claim 1, wherein said operational member comprises an operational body section and a light guide section, and the light from said light source is supplied to the said operational body section through said light guide section.

3. A device according to claim 2, wherein the light from said light source is supplied to said light guide section from a side of said operational body section and said light guide section comprises a reflecting portion that leads the light supplied to the light guide section to said operational body section.

4. A device according to claim 1, wherein a plurality of selective modes corresponding to operations of said image-indicating device is provided and said light source can selectively emit a plurality of colors corresponding to said modes, so that a light with a color corresponding to a selected mode is supplied to said operational body section.

5. A device according to claim 1, wherein a function of said operational member includes a function relating to said image-indicating device.

6. A device according to claim 1, wherein said portable electronic device comprises binoculars.
